(19) United States
(12) Patent Application Publication
(10) Pub. No.: US 2013/0304667 A1
(43) Pub. Date: Nov. 14, 2013

(54) Method and System for Promoting Arbitration Between Evaluators and Evaluees

(71) Applicant: Fritz G. Reisch, San Diego, CA (US)

(72) Inventor: Fritz G. Reisch, San Diego, CA (US)

(21) Appl. No.: 13/893,271

(22) Filed: May 13, 2013

Related U.S. Application Data
(60) Provisional application No. 61/646,081, filed on May 11, 2012.

(51) Int. Cl. G06Q 30/02

(52) U.S. Cl. CPC G06Q 30/0282
USPC 705/347

(57) ABSTRACT

A computer enabled system operating over a network such as the internet, employing software adapted to register both users and recipients of user reviews. The system endeavors to maintain the accuracy of product and service provider ratings by employing a relational database of users and review recipients stored in relational databases in electronic memory. Users input evaluations of providers which may be reviewed by providers and accepted and published or contested. Mitigation services between users and providers are provided to allow restitution to render evaluations acceptable to providers. Electronic identifiers associated with users may be employed to prevent multiple evaluations by supposed different users and prevent skewing ratings of providers.

This application claims priority to U.S. Provisional Patent Application Ser. No. 61/646,081 filed on May 11, 2012, and incorporated herein in its entirety by this reference thereto.

### BACKGROUND OF THE INVENTION

1. Field of the Invention

The present invention relates to information resource services. More specifically the invention relates to an online information resource service which is especially well adapted for online or internet-based use by users to evaluate, rate, comment, review, and acquire information about individuals or business entities. The service and related method therein further promotes an arbitration service between evaluators and evaluees when a potentially unfavorable evaluation is reached by a user who is an evaluator of a provider who is the evaluee, in order to maintain a more accurate standing for all parties.

2. Prior Art

The Internet provides an immensely huge resource to allow virtually anyone to shop, sell, socialize, learn, and play, among various other network accessible endeavors. However, even within in the information age, people often seem know very little background concerning each other. This background deficiency is even more apparent when a product or service is being purchased and the purchasing individual and the provider must live up to promises and contractual obligations.

Many individuals and business entities try to advertise their client-loyalty or quality of service via large advertising campaigns and/or more simply through word of mouth and social media. However, these methods can only go so in ascertaining pertinent information which really provides a consumer a confidence and positive feelings about a business, service, product, being purchased or dealing with an other individual with whom they are considering a business transaction.

There exist many conventional services which allow consumers to gain some insightful information about people or businesses. For example credit agencies allow people to view credit scores to give an insight on how people/businesses run financially. The Federal Trade Commission (FTC) and the Better Business Bureau are examples of agencies or services which provide some information regarding consumer protection and some business practices. However, these and similar information provision services seem to merely provide one dimensional evaluations. The average consumer generally desires to gain information on an more insightful level of information about the individuals and business they are to encounter in business or other walks of life.

Such useful information most preferably originates in reviews from another consumer who has had one or a plurality of previous personal experiences with the individual, product, or service being considered by a subsequent consumer. Such reviews can be found in conventional consumer-based web resource rating services such as Amazon, ebay, YELP, Reseller ratings, Complaints, ANGIE'S LIST, as well as others.

Using these type services over a network, customer-users can publicly review, rate, and provide evaluations about businesses or services which they have experienced. Subsequent potential users may view in order to make informed decisions about possible dealings with reviewed businesses and people. Average consumers believe, it seems, that by reading evaluations from other consumers like themselves, they are getting more fair and more balanced information then would be received directly from a vendor or service provider or their advertising and promotions.

However, the noted and similar user rating services fall short in the provision of fair reviews in many aspects. In some instances, evaluations or posted comments may be extremely biased or slanderous. Often theses types of evaluations are given in spite by competitors, or by users who may have inadvertently suffered or perceived to suffer, a single unpleasant experience with the individual or business. However, such one sided and infrequent reviews tend to rise to the top of the reviewed ratings and don not give the evaluaee a fair review nor a chance to redeem or explain themselves.

Further, any problems a user may have or perceive with a particular vendor or service provider, quite possibly could have been easily rectified if there were some manner of providing input by the offended consumer and a means for response or restitution from the entity involved. Many such disagreements stem from misunderstandings or skewed expectations by and between the consumer and the service or product provider. However neither party in the current system is made aware of the true nature of the problem and a work-around reached. Instead tempers and reactions tend to get the best of the consumer or provider due to the lack of communication. Some may be deserved, while many times a simple misunderstanding elevates to a major poor review by a consumer and equally poor response by the provider. Subsequent consumers only view the result of mis communication which as noted is frequently not providing an accurate representation of either party.

As a consequence, many businesses, individuals, and service providers, have received reviews imparting to them a bad reputation without the opportunity to correct the perceived problem of the party inputting that review. Further, the provider is given no manner to receive the input from a customer about perceived problems and jointly attempt to rectify or clarify them, before a customer's irritation elevates to the point of writing a scathing review.

Such a system is not fair to the vendor or service provider who in the age of the internet and social media, can lose a lot of business based on an inaccurate review from a mistaken customer. Nor is the current art beneficial to buyers or consumers who have input bad reviews since their complaint or problem is not rectified by writing a bad review. Neither is it beneficial to subsequent users of the social network, industry website or database who may form a skewed opinion of a vendor or service provider which is based on an undeserved single bad review from an irritated customer.

Still further, it is possible with these conventional methods that an individual or business being reviewed, and the reviewing site hosting the input reviews, has no way of knowing that they are receiving a valid evaluation in the first place. As such, slanderous or undesirable comments from non-customers may be uploaded to the viewable comments available for public review without the vendor or service provider's knowledge nor ability to rectify. Such can continue to damage their reputation for many months or years.

As such, there is a continuing unmet need for an improved information resource service and method which provide a means to review, rate, or otherwise evaluate individuals or business entities and which first provides a means for arbitration for both the customer and the business or person involved, as needed, to resolve perceived wrongs by both consumer and seller or service provider. Such a system would eliminate a good percentage of unfavorable customer opinions and resulting negative evaluations which is the current single path for irritated consumers. Such a service should endeavor to inform businesses of customer complaints which allow the business to rectify a customer-perceived problem if it exists, and improve customer service. Such a system would give subsequent users a more secure feeling the knowledge they are viewing about prior consumers is accurate.

To that end, such a method and service should advantageously allow these individuals or entities to arbitrate, or mediate, where a customer perceives they have not received adequate value or service from a vendor or service provider. Such a service should endeavor to eliminate unfounded or unneeded bad reviews of businesses, and to inform a business of a customer problem, and give them the ability to rectify it or respond, before the mood of the customer turns ugly. Such a service should provide businesses a means to monitor the information uploaded about them, to ascertain if the reviews are from actual customers, and to provide restitution if necessary, in order to provide fair and balanced reviews for public viewing.

Finally such a system should provide a rating system not just for vendors and service providers performance and lack of or number of problems themselves, but also a rating on how individual vendors and service providers dealt with complaints and problems as part of the entire review. Finally such a system should endeavor to ascertain if such reviews are from actual clients prior to posting online, and, in some cases to rate the customer for reasonableness where it is discerned by the system a customer has input negative reviews in excess of a norm.

### SUMMARY OF THE INVENTION

The computer and network enabled system herein disclosed and described provides a solution to the shortcomings in prior art and achieves the above noted goals through the provision of a network accessible menu driven information resource service employing client and provider database information to calculate and provide ratings to customers. The service and method is employable as a network or web accessible or online-line based service for both customers for products and services, and vendors of products and service providers.

In a particularly preferred mode registered users (herein ‘user’ refers to the ‘evaluating party’ or ‘evaluator’) may log onto a website hosted by a network accessible server of the provider via a computer hosted web browser. In such a communication between user and the software running on or communicating through the server, a user can post comments and rankings about other parties registered on the site, including; individuals such as contractors, accountants, service providers, a politician, large business entities such as DISNEYLAND, and other individual service providers, and product vendors. Such providers herein may be referred to as the ‘recipient’, ‘evaluee’, ‘evaluated party’, or ‘entity’.

As an advantage over prior art, it is particularly preferred that the input user comments or evaluations are first saved to computer memory, and are first reviewed and/or approved by the receiving party subject to an input and/or action by the evaluated party of the review.

Approval by the system operator or receiving party, based on input and/or actions by the evaluated party, is a key action which is missing from prior art in the area of product and service provider review such as those listed above. This step provides great advantages to both the evaluated party, and subsequent users who review such ratings, as well as the current user. Further, the disclosed service and method herein provides an additional advantage over prior art by providing means for mediation or means for arbitration to thereby allow the evaluator and evaluee, a means for resolving a perceived problem which is an issue of unfavorable or slanderous evaluation. Such an individual or plurality of actions must occur before a negative evaluation is allowed by the service operator to be posted. This has the benefit of allowing the evaluator and evaluated party, to maintain a good and honest reputation to subsequent users of the website.

As will become apparent upon further disclosure it is one object of the present invention to provide a means to better human relations, especially business oriented relations, by allowing users to voluntarily input data concerning purchases or services and products, which is maintained electronically in a relational database of information about interaction of users with product and service providers an other parties or entities. Further a means for feedback from user consumers is provided, the accuracy of which is protected from competitors or irrational consumers by the provision of a review of incoming reviews themselves. Following such review, a means for mediation or arbitration is provided to ascertain solutions to perceived problems from the input review, before a final review is publicly posted. The steps of reviewing all incoming reviews and validating the reviewer as well as ascertaining problems in the review which might be rectified by provided mediation or arbitration, before the allowance of the posting of a poor evaluations, serves as a means for reputation management for service and product providers, and means for rectifying a perceived problem for the user.

Additionally, subsequent users of the service in reviewing actual posted reviews online, will benefit. This is because as members or subscribers to the service, they are aware that a negative review which is posted is most likely deserved since the service provider only allows such postings after mediation or arbitration occurs between the posting customer and product or service provider. Subsequent users need not wonder about the accuracy of negative and positive reviews which are posted subsequent to a review by the providing site and at least an offer of mediation or arbitration.

In general, the computer enabled software providing network access such as over the internet, employs a database and provides input pages displayed on the video display of remote users computing devices, which allows any subscribing user, to post comments and rankings about other service or product provider or entity. The subscribing user is known to the system through their input email address, communicated social networking user information, computer MacID, or other known unique contact identifier discernable by the system to validate the identity of the user providing information into the database.

In a particularly preferred mode of the system, users as well as entities create and register their respective electronically stored profiles within the system which are saved in a relational electronic database maintained by the system provider. Subscribing users once cross referenced with electronic identifiers as to their identity, and saved to the database, may become free members of the service. Subscribing users may also be paid members of a system provided by the service provider, wherein additional services described herein may be provided. Individual subscribing users may simply provide their name and their contact information, and cross referenced with a discerned identifier such as a MacId from their computer, or a user name and password, to validate their presence and any inputs to the system. Commercial entities such as product and service providers, may choose to provide additional background information such as services provided, advertising, industry awards or certifications, and other such information which may be of interest to a researching user.

Any identified user may voluntarily input a review or create an evaluation of any other service or product providing entity simply by inputting an identifier of the entity they wish to review, or searching the system provider database of product and service providers and then providing input on a user identified provider from the results. Such a search query input to the searching routine of the software running the system, can be based on a known email address, telephone number, or other user-input identifier related to the entity in the relational database. If the entity has a profile within the database, which matches the search information input by the subscribing user, the entity profile will be displayed and the subscribing user will be communicated a webpage for input of information for an evaluation process which will be input by the subscribing user. Subsequent to the input of the evaluation by a user, the reviewed entity will receive notice thereof.

Alternatively, when the entity does not have a profile within the database, but through internet searching or other means for ascertaining contact information the entity and contact information is identified, the non subscribing entity will then receive an electronic or mailed notice that an evaluation is or has taken place whereafter they will be prompted to create a profile on the system and become a subscribing entity. The entity may then choose to create a profile or not, and may choose to accept (approve) the users evaluation for public disclosure, deny the evaluation such that the comment or post will not be viewable (opt out), or employ the service provider mediation or arbitration service to resolve any unfavorable or slanderous comments or reviews.

In accordance to at least one preferred mode of the invention, it is additionally particularly preferred that the recipient will not be allowed to review (approve or deny) a certain type of evaluation, such as a non written evaluation. This non written evaluation may be a number ranking, letter grade, or other ranking of the like which is not as subjective and word-based as a written review.

For example, in the absence of agreeing to arbitration or mediation, the recipient of a review, may choose to deny written comments that may be slanderous, but will not have the option to deny or hide a negative ranking. Therefor a fair and balanced evaluation can be provided via the posting of the ranking on the network accessible website, however without the inclusion of slanderous or undesirable written word evaluations. It is additionally preferred that individual and aggregate total rankings may appear on the entities profile in a graph or chart form to be visible to the public. It is noted that in other modes of the invention, the user may have the option to completely deny all types of evaluations, written or not, however is less preferred.

In accordance with at least one preferred mode, the invention may include various types of ranking and/or ranking displays. For example, there may be a certain rank based solely on customer satisfaction, another on investor satisfaction, while another may be on employee satisfaction, and others. Further, the ranks can be displayed as temporal aggregate ranks over various time frames, such as the last month, the last quarter, the last year, and years, to give the public an idea of the trend of satisfaction of a service or product providing entity over time.

Should the recipient choose not to create an entity profile with related contact information and history, within the database for whatever reason, the user input ranking and a generic entity identifier provided will be viewable, however no further information about the entity will be provided (i.e. name, address, business services, etc.).

As can be imagined, many business entities will find benefits from receiving positive evaluation from users as a positive reputation will be maintained and portrayed to the public. As such, in a particularly preferred mode of the invention, should a recipient be in line to receive a less than favorable evaluation, the recipient may choose to dispute, as opposed to deny, the incoming comment or post and then attempt to resolve any issues with the evaluating party through an arbitration service.

If successfully, the unfavorable evaluation may be avoided, the user who intended the negative evaluation will be made whole, and, the system can also track and provide information to users, on the rating of the recipient vendor or service provider in rectifying errors or poor customer service. This would be a most important potential source of new information for consumer users of the system in that they will be able to ascertain aggregate ratings on vendor and service provider history of rectifying actual and perceived poor products or service and customer complaints. It is well known that customers will accommodate and actually re-visit vendors who fix a problem well, and will not remember what went wrong on many occasions, but just how the product or service provider reacted and resolved the problem. Consequently ascertaining ratings for the vendors and service providers of the service, for customer service and accommodation would be a valuable new tool for user customers to rate potential vendors and service providers.

If the recipient and evaluating party choose to attempt a resolution of the problem, it can be commenced either between the parties themselves, or with designated third party arbitrators can be employed for a fee. For example, when users desire not to directly resolve discrepancies, each may be represented by an arbitrator to provide resolution. If a resolution is still not accomplished in this first mode of mediation, a yet additional arbitrator may be employed or provided by the service, preferably for a fee by the user and recipient, who agree to abide in advance by the decision.

Still further, in another mode of the service, a user may pay into an insurance service if either of the parties is still unable to resolve a discrepancy or if one party decides to cancel the paid membership with the service. As such, unpaid amounts and discrepancies may be covered by the insurance.

Resolution of any discrepancies can be accomplished by financial restitution to the user/reporting party, or any other suitable means decided upon by both parties or the ultimate arbitrator. In addition, while restitution is still in dispute, the service may act as a kind of escrow wherein funds are held but not paid out until the transaction is satisfactorily closed out.

For example, in one preferred mode, through voluntary profile registration over the network and profile data stored within the database, users and product vendors and service providers can choose to employ the system provider of the service to escrow funds (the service acting like a credit card and/or futures/commodity clearing house) until the service or product provided by the entity is completed and satisfactory to the user.

The disclosed invention comprises still an additional component within the service, namely, the third party arbitrators or mediators. The arbitrators are individuals such as trained mediators, or other such persons suitable for the intended purpose, who create mediator profiles within the database.

In yet another particularly preferred mode of the system, the evaluating user and evaluated party may additionally provide evaluations about the arbitrators. Other users and entities who desire arbitration service in the future can then view the rankings of arbitrators themselves within the database in order to properly choose an arbitrator as needed.

Finally, in another temporal mode of providing current and aggregate data over time frames, the system can provide ratings not only on a company, but also the individuals operating the company, and if national or international, a rating on the corporate office. In this fashion, for instance individual mechanics at a dealership could be rated for customer service, the dealership could be rated as a business and for their handling of restitution and customer service, and the corporate entity could be rated for matters which involve them, such as honoring warranties. The ratings can be both individual, and aggregate over one or more time periods to show a trending and to show individual ratings.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and mayor may not be present. By “consisting of’ is meant including, and limited to, whatever follows the phrase “consisting of”. Thus, the phrase “consisting of” indicates that the listed elements are required or mandatory, and that no other elements may be present. By “consisting essentially of’ is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and mayor may not be present depending upon whether or not they affect the activity or action of the listed elements.

It is an object of the invention to provide a information resource and evaluation database which is especially well adapted as a web or online-line based service.

It is an object of the intention to provide a resource database which allows users to provide evaluations of other users such as individuals or business entities.

It is another object of the invention to provide means for an evaluation recipient to manage the content of evaluations.

It is yet another object of the invention to provide arbitration to allow evaluators and evaluees to resolve disputes and provide restitution if necessary.

### BRIEF DESCRIPTION OF DRAWING FIGURES

FIG. 1 shows a flow chart of the disclosed computer enabled system herein detailing how a user would provide an evaluation (written comment or number rank) for the recipient to review prior to public posting.

FIG. 2 depicts a flow chart of a review recipient reviewing procedure.

FIG. 3 depicts a flow chart of a preferred mode of the invention acting as a commodity clearing house.

### DETAILED DESCRIPTION OF THE PREFERRED EMBODIMENTS OF THE INVENTION

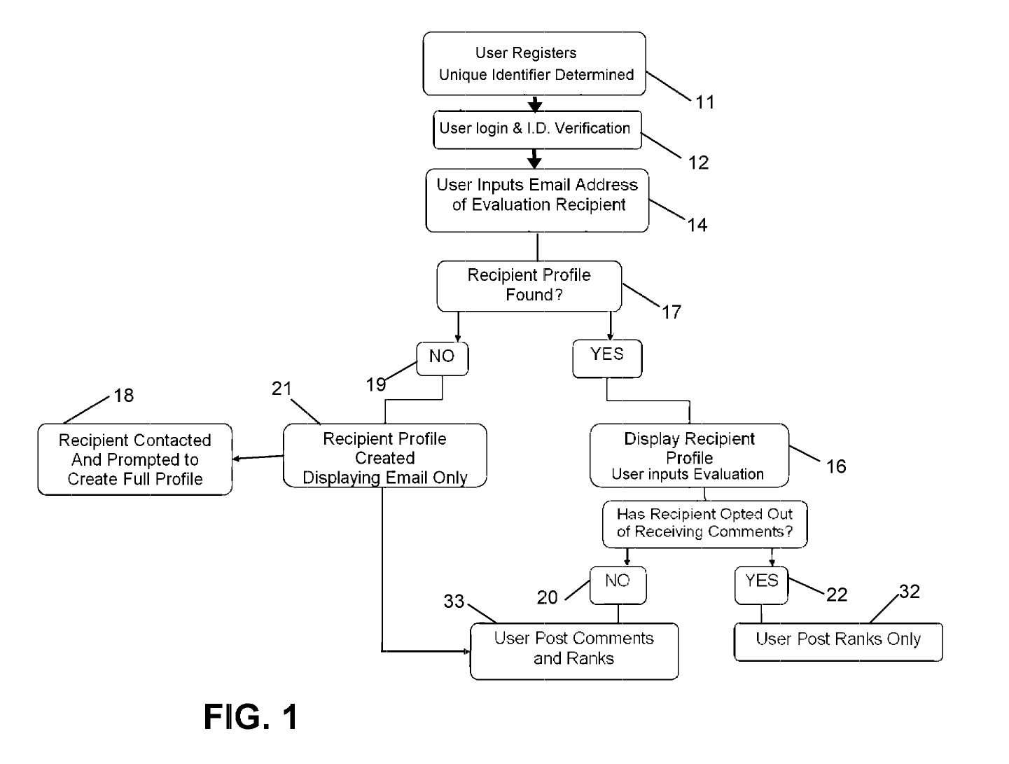

Now referring to drawings in FIGS. 1-3, wherein similar steps in the system are identified by like reference numerals, there is seen in FIG. 1 a flow chart for the system 10 detailing one or more preferred modes of carrying out the method or system 10 of the invention.

In a first step users visit a webpage hosted by a server of the service provider or a network such as the internet, and register by providing contact information and a subscribing user chosen user identifier during their entering of a profile 11. All of this information is correlated in a relational database 16 with the input user profile information. For instance the user will provide a username and password, and their email for user identifiers, all of which may be used for a subsequent user login and for identifying themself as a subscribing user.

Alternately but preferred, a secondary electronically determinable identifier is determined 12 and related to the user profile 11 in the database. The unique MacId of the user machine network card, or cards if they use more than one machine, or the IP address of the user machine, or both the IP address and the MacID of the machine, can be determined by software on the service provider server, and stored in a relational database associating subscribed users with their computer for verification on subsequent logins. In this fashion the subscribing user on a return visit, may be verified as the known subscribing user by ascertaining matching IP addresses or computing device MacID or both. This is an important step to keep the results in the system accurate and honest and to prevent multiple good, or bad, evaluations being input from a single computer or computing device, for the same evaluation recipient in attempts to impart a skew to ratings where competitors may attempt to input bad evaluations, or friends of a subscribing recipient might attempt to input multiple good reviews to influence ratings.

With at least one, and preferably two electronically discernable identifiers of computing devices, matched to subscribing users in the relational database 16, such multiple inputs can be prevented by either ignoring subsequent input evaluations for the same subscribing recipient. The subscribing user attempting such multiple inputs may or may not be told they have been identified. If they are not so informed, the subsequent input evaluations would be ignored and not used in rankings and, the offending subscribing user's subsequent evaluations of other subscribing recipients may be downplayed in the rankings of the subscribing recipients using software adapted to lower the value in determining a ranking of a subscribing recipient, when it comes from and identified abusing subscribing user.

Once the profile of the subscribing user is entered and stored in the system database, thereafter when a logged-in subscribing user starts to create an evaluation, the subscribing user enters some user-chosen recipient-identifier the system 10 may employ to ascertain an identity for the proposed recipient of the intended evaluation. Such may be for instance, the recipient's name, or a published phone number or address, or an email address 14.

The system 10 then employs software adapted to the task of looking up in the stored relational database 16 which includes subscribing recipients, who have registered their subscribing recipient profile with the system 10, to ascertain if the intended recipient for input by the subscribing user, is a subscribing recipient member 17 already or not.

If the system 10 determines a match to the recipient identifier 21, the system 10 discerned potential evaluation recipient is communicated over the network to be displayed to the subscribing user on their computing device. Then the subscribing user is provided space on the displayed webpage, to input their comments or rating 16 in the evaluation of the discerned recipient.

If the recipient is determined as not to be a subscribing recipient, and sufficient data exists to identify and/or contact the intended recipient, the discerned recipient may be contacted and requested to input a profile 18, and thereafter create their recipient profile 20, which may be shown to the user inputting the evaluation and subsequent users.

The subscribing user evaluation 16 can include one or a combination of the following; written comment, letter grade (A-F), number rank (1-10, or 1-100), aggregate ratings (1-10) of all users over time, or over time frames to show a trend, and can also include ratings (1-10) of vendors and service providers in their handling of customer service and complaints, or other suitable means. Again, subscribing users preferably log into server communicating a webpage over a network provided by the service 10 provider using a web browser over a network such as the Internet and can post comments and rankings about other parties such as product and service vendors. These evaluation recipients can be individuals, as well as business entities.

It should be noted that the system 10 in depictions of flow charts of preferred procedures of the present invention are provided merely to give a guide to help portray the overall scope and intent of the invention and should not be considered limiting. It is understood that various modification or alterations to the flow of the procedures may be necessary in order to carry out the intended operation while staying within the overall scope of the invention, and are anticipated.

As noted the system 10 operated by the system provider included network accessible server running software adapted for input and matching of user and recipient profiles in a voluntarily joined relational database 16 wherein evaluations may be posted for public viewing. However, unlike conventional services where such a user evaluation is generally immediately posted publicly, the system 10 herein allows the evaluee or receiving party, vendor, or service provider, to receive and review the intended evaluation input by a subscribing user 15, prior to any public posting.

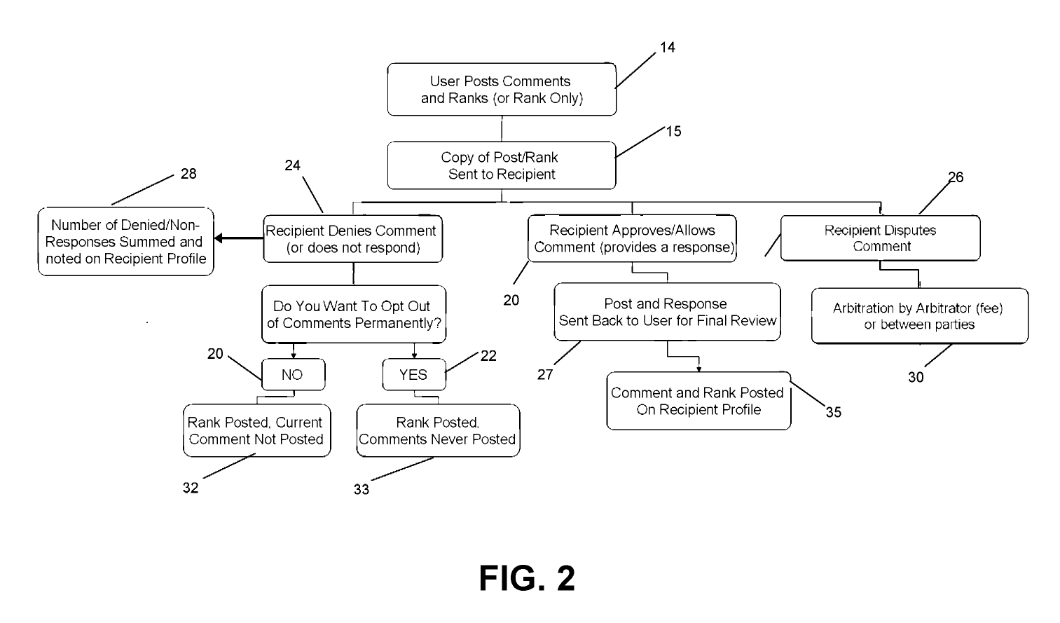

In general, a subscribing receiving party, upon receiving a copy of a user evaluation 15, (FIG. 2) may agree tp accept the evaluation 20, deny the posted evaluation 22, or to dispute the posted evaluation 26 prior to publication. If disputed the system 10 may track the number of disputed posts 28 to show if it is a recipient habit. If the recipient disputes the post 26, they may request to mediate or arbitrate 30 any discrepancies discerned in the user's perceived lack of service or value.

The flow chart of FIGS. 1 and 2 provides a general procedure of how a user will create an evaluation or comment 20 or rank evaluation and how the recipient can interact.

Individuals or business entities such as product vendors and service providers, subscribing to the system 10 will be provided web pages displayable on their computer to create a provider or recipient profile 21 to be stored and electronically related to their profile, within the database to provide users with information regarding their business/service.

The business profiles created 21 can include information consisting of the following; name, address, phone number, business, education, pictures, advertising, background info, webpage, or other such information. Further, as will described in detail later, the profiles will additionally include a listing of past evaluations (written comments and rankings), as well as other informative data regarding the users interactions with other users (i.e. has the user opted out of receiving comments, number of comments denied, number of comments removed, number of views by users, etc). Aggregate as well as individual ratings in various categories may be provided, as well as ratings for problem-solving and customer service. Further, ratings of individual employees, the local company, and a national parent company, for their areas of customer service and provision of products and services, can also be kept in a relational database, and provided to users.

The user, through interaction upon a system provided a web page for example, can search using a search engine on the site, or enter a unique vendor or service provider identifier, such as an email address, of an entity they wish to evaluate during login and evaluation input 14. It must be noted that the unique service provider identifier is not limited to email addresses only but can be one from a group consisting of full name, address, social networking user name, phone number, or other suitable unique identifier. A search through the stored information in the relational database will then reveal if the searched party already has a profile set up within the database.

As shown in the chart of FIG. 1, if a recipients profile exists 17, it is then determined if the entity has opted out 22 of receiving written comments. This is an option open to all profiled recipients and will be discussed in more detail shortly below. If particular recipient has ‘opted out’ 22 of receiving comments, then only the users rank 32 evaluation will be publicly posted. Again the rank is considered a non-written evaluation. Alternatively, if the recipient has not opted out 20, then the users posted comments or evaluation are sent to the recipient 15 for review (FIG. 2) which must occur prior to final posting 33.

Now referring to the chart of FIG. 1, it is possible that the recipient is not known within the database 19. In this case, a temporary provider profile displaying a unique identifier inputted by the user is created and the comment or post temporarily stored for later association with the permanent profile of the provider.

Concurrently, to pair a provider with the unique identifier in the temporary profile, the recipient of the user input will be contacted 18 and informed that a evaluation about them is present, prior to its public posting. The recipient can then create a profile 21 as discussed above, or may choose to maintain the temporary profile. In either case, the recipient may then review the post, deny it 24, dispute it and request mediation 26, or do nothing wherein the comment will be publicly posted 32.

FIG. 2 shows a flow chart detailing this procedure of the recipient's review prior to public posting. Briefly this chart generally follows from the end of the chart of FIG. 1. Once the user has created a post or comment, it is sent to the recipient for review 15. As a first option the recipient may deny the comment 24, for reasons such as foul language, slanderous comments, or simply by preference. In the case of denying the comment 24, the database will record all instances of denial or non-response, and this information may be present on the user profile in numerical and/or graph form, along with the recipients reason on why the post was denied. This aspect of the invention is provided to dissuade evaluee's from unfairly denying all comments which are simply unfavorable and not necessarily slanderous.

Although it is preferred that the evaluee or recipient can deny 24 slanderous or hurtful comments, it is a desired aspect of the invention that honest evaluations, even those which are unfavorable to the recipient, can be posted to provide an overall fair and honest evaluation. Therefor, if the recipient chooses to deny a comment simply because it is unfavorable, then the overall rank of the recipient may go down.

The recipient may choose to simply deny the current comment, or can choose to opt out 20 of all comments from the particular user, if that user is determined a particular problem, or all users in general. In this case, as mentioned previously, user rankings will still be posted and viewable to the public.

Referring now to the middle of the chart in FIG. 2, the recipient may accept/approve the users evaluation 20. The recipient is also given the chance to respond to the user about the comment, and provide further information to the user should they desire. If such a response occurs, the user may then be given the opportunity to edit or change the comment in a final review 27.

In mediation or arbitration if requested 30 the user and recipient may rely on a set of ground rules related to the content of the posting, such as providing references or other additionally details. In this case the posting may not be publicly viewable 35 until ground rules have been abided by and confirmed.

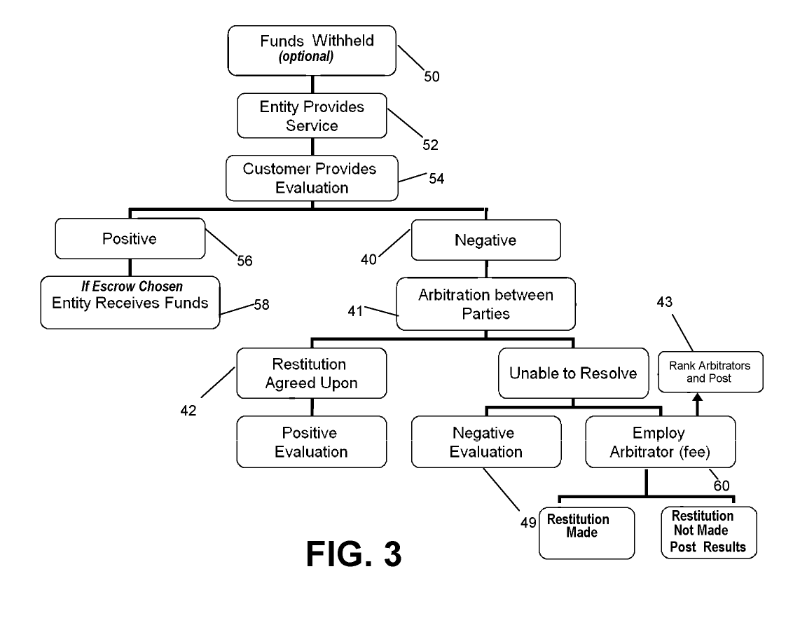

A further particularly preferred aspect of the invention is the provision of an arbitration or mediation service to subscribing users and providers. This particular aspect of the invention is generally available to the recipient provider when they have chosen to dispute a user evaluation, as shown on the right side branch of the chart of FIG. 3. In the case of an unfavorable review 40, the business entity (recipient) may wish to resolve any problems in efforts to instead receive a positive review and defend/maintain their good name.

In a first preferred mode of the system 10, this can be resolved by the business entity in arbitration 41 or prior to, agreeing to provide a kind of restitution, monetary or not, to the evaluating user during the evaluation review process by the recipient prior to public posting 35. The kind and amount of restitution 42 can be decided by the parties themselves, or an arbitration service 41 can be provided for a fee, providing a revenue stream for the service.

Arbitrators are additional user providers within the service, and employing arbitration 60 is chosen, they too may be ranked 43 by users based off previously arbitration services provided by them. When a user and entity decide to employ an arbitrator provider, a fee may be required.

A courtesy rating for the business for its handling of customer problems and complaints may be kept and provided as a means to rate businesses. This can be done with individual ratings from the user customers, and the arbitrators, on how well the business handled the perceived problem. Individual as well as an aggregate numerical rating over time can be kept in the database as a means to rate businesses for subsequent customers.

Additionally, a rating of the users who make comments and complaints about providers, may also be kept so as to ascertain if certain users have a proclivity to complain about everyone and everything. This could be hot-linked to viewable complaints and negative evaluations 49 about businesses by such users to subsequent user customers can ascertain the nature of the source of the complaint.

As noted a rating of the arbitrators 43 can also be maintained from input of the users and businesses so as to provide subsequent potential arbitration participants input on potential arbitrators. In yet another particularly preferred mode, the system will provide a settlement service, such as a clearing house, where funds are tendered and withheld 50 until restitution has been satisfactorily closed out either by the parties or the arbitration service. An procedural example is shown in the flow chart of FIG. 3. This option will more then likely be provided to users who have existing profiles within the database and may additionally be required to pay charges for such a service.

In general, users and provider entities who are subscribers within the settle service aspect of the system, agree to have funds with held 50 during a business transaction between the user and entity until complete. After providing a business service 52, the costumer/user reports back to the database with an evaluation of the service 54, providing comment and rank evaluations as described above. If an evaluation is generally positive (i.e. accepted by the entity) 56 the funds will be transferred to the entity 58 and the transaction is completed as shown in the left branch of the chart.

However, referring now to the right branch of the chart in the figure, if the customer/user is generally dissatisfied and negative 40, the entity may dispute the evaluation and resolve any discrepancies through arbitration 41. In a first preferred mode particularly intended for user's employing the service for free, arbitration is settled between the two parities themselves. Resolution 42 can come from monetary restitution, discounts for future services, or the like, which is deemed satisfactory by the user/customer. As such the user will more then likely provide a positive evaluation to the entity and all parties are satisfied. However, in yet another mode, if the user and entity are paying members of the settlement service 60, the services of an arbitrator will be employed to determine restitution.

However, for non-paying members, should the parties be unable to resolve any issues, then additional choices are available. First, the user and entity may choose to employ an arbitrator at a fee, wherein the arbitrator has final say in means for restitution. This however may still result in a negative evaluation of the entity due to continued dissatisfaction by the user.

In accordance with still yet another mode of the invention, entities and user may subscribe to an insurance service, which would cover costs of restitution if either or both parties cannot agree on any resolution either themselves or through an arbitrator, or if one party decides to simply cancel the services provided by the invention.

The current disclosure has been provided to describe an information database service and method providing voluntary evaluation and review services. It is an apparent advantage over prior art that the evaluation recipient is provided with a means to review written comments about them, and arbitrate any discrepancies, in efforts to dissuade slanderous or hurtful comments however still providing fair and balanced reviews, and maintain the good name of the parties involved.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A system for maintaining accuracy of product and service provider ratings, employing a relational database stored in electronic memory which includes subscribing user profiles and subscribing recipient profiles, and employing software enabled by and running on a network accessible server to publish evaluations after at least a review by subscribing recipients, employing the steps of:
allowing users to input user information to register as subscribing users with said system;
storing said user information in user profiles in a relational database;
allowing potential evaluation recipients, to input recipient information to register as subscribing recipients;
allowing said subscribing users, to input said user information and subsequently log into said system as a said subscribing user;
allowing said subscribing users to communicate with the system over a network to input identifying information for an intended recipient of an intended said evaluation;
employing software running on a computer to lookup in said relational database and ascertain if a recipient match exists between said intended recipient, and a subscribing recipient;
if said recipient match does not exist, employing software adapted to the task of identifying said intended recipient of said evaluation initiating a contact said intended recipient;
including in said contact, an input screen remotely displayable on a said computing device which allows said intended recipient to input information rendering them a said subscribing recipient;
allowing said subscribing user to input a said user evaluation of a recipient of said user evaluation;
ascertaining a match in said database, of a said subscribing recipient of said user evaluation;
forwarding said user evaluation to said subscribing recipient ascertained as said match;
allowing said subscribing recipient ascertained as said match, to identify said evaluation as an accepted evaluation or a contested evaluation;
publishing said accepted evaluations on a webpage accessible on or through said network accessible server; and
providing a mitigation service between a said subscribing user and a subscribing recipient for said contested evaluations whereby said contested evaluations may be resolved to accepted evaluations, or remain a said contested evaluation; and
publishing said evaluations resolved to accepted evaluations, and publishing said contested evaluations in combination with any response by said subscribing recipient.

2. The system for maintaining accuracy of product and service provider ratings of claim 1, additionally comprising the steps of:
ascertaining at least one unique electronic identifier of a computing device employed by each said subscribing user;
matching a respective said electronic identifier with said user information employed by a said subscribing user during a said log into said system;
employing software adapted to the task of ignoring or discounting a said evaluation of a said subscribing recipient if multiple said subscribing users match the same said electronic identifier, whereby multiple said evaluations associated with the same said electronic identifier which may impart a skew to ratings of a said subscribing recipient, are eliminated prior imparting said skew.

3. The system for maintaining accuracy of product and service provider ratings of claim 1, additionally comprising the steps of:
providing a mitigation service between a said subscribing user and a subscribing recipient which includes a restitution being provided to said subscribing user from said subscribing recipient in return for a change in said evaluation from said subscribing user rendering it a said accepted evaluation.

4. The system for maintaining accuracy of product and service provider ratings of claim 2, additionally comprising the steps of:
providing a mitigation service between a said subscribing user and a subscribing recipient which includes a restitution being provided to said subscribing user from said subscribing recipient in return for a change in said evaluation from said subscribing user rendering it a said accepted evaluation.

5. The system for maintaining accuracy of product and service provider ratings of claim 3, additionally comprising the steps of:
providing an escrow service for deposit of said restitution by a said subscribing user;
communicating a proposed evaluation to said subscribing recipient; and
tendering said restitution to a said subscribing user subsequent to a communication from said subscribing recipient communicating said proposed evaluation is an accepted evaluation.

6. The system for maintaining accuracy of product and service provider ratings of claim 4, additionally comprising the steps of:
providing an escrow service for deposit of said restitution by a said subscribing user;
communicating a proposed evaluation to said subscribing recipient; and
tendering said restitution to a said subscribing user subsequent to a communication from said subscribing recipient communication said proposed evaluation is an accepted evaluation.

7. The system for maintaining accuracy of product and service provider ratings of claim 1, additionally comprising the steps of:
if no said match is ascertained, employing said identifying information for a said intended recipient of a said intended said evaluation, to contact said intended recipient; and
allowing said intended recipient to input information to become a said subscribing recipient.

8. The system for maintaining accuracy of product and service provider ratings of claim 2, additionally comprising the steps of:
if no said match is ascertained, employing said identifying information for a said intended recipient of a said intended said evaluation, to contact said intended recipient; and
allowing said intended recipient to input information to become a said subscribing recipient.

9. The system for maintaining accuracy of product and service provider ratings of claim 3, additionally comprising the steps of:
if no said match is ascertained, employing said identifying information for a said intended recipient of a said intended said evaluation, to contact said intended recipient; and
allowing said intended recipient to input information to become a said subscribing recipient.

10. The system for maintaining accuracy of product and service provider ratings of claim 4, additionally comprising the steps of:
if no said match is ascertained, employing said identifying information for a said intended recipient of a said intended said evaluation, to contact said intended recipient; and
allowing said intended recipient to input information to become a said subscribing recipient.

11. The system for maintaining accuracy of product and service provider ratings of claim 5, additionally comprising the steps of:
if no said match is ascertained, employing said identifying information for a said intended recipient of a said intended said evaluation, to contact said intended recipient; and
allowing said intended recipient to input information to become a said subscribing recipient.

12. The system for maintaining accuracy of product and service provider ratings of claim 6, additionally comprising the steps of:
if no said match is ascertained, employing said identifying information for a said intended recipient of a said intended said evaluation, to contact said intended recipient; and
allowing said intended recipient to input information to become a said subscribing recipient.
